(19) United States
(12) Patent Application Publication
(10) Pub. No.: US 2017/0336912 A1
(43) Pub. Date: Nov. 23, 2017

(54) IDENTIFICATION MODE AND INPUT MODE OPERATED INPUT DEVICE

(71) Applicant: PREH GMBH, Bad Neustadt A.D. Saale (DE)

(72) Inventors: MANUEL STOTZEM, Wuelfershausen (DE); ANDREAS KAIL, Bad Neustadt A.D. Saale (DE)

(73) Assignee: PREH GMBH, Bad Neustadt A.D. Saale (DE)

(21) Appl. No.: 15/595,954

(22) Filed: May 16, 2017

(30) Foreign Application Priority Data
May 18, 2016 (DE) 10 2016 109 142.1

(51) Int. Cl. G06F 3/041; G06F 3/044; G06F 3/042; G06K 9/00; B62D 1/04

(52) U.S. Cl. CPC G06F 3/0416; G06K 9/0002; B62D 1/046; G06F 3/0421; G06F 3/044

(57) ABSTRACT

An input device includes an input area, an optical or capacitive sensor which includes a scan area, and an analyzing unit. The optical or capacitive sensor detects a surface structure of a finger touching the input area in the scan area. The input device operates in an identification mode where the surface structure located in the scan area is detected via the optical or capacitive sensor. The input device also operates in an input mode where at least a sub-area of the scan area is detected at least once via the optical or capacitive sensor and is analyzed by the analyzing unit so that the analyzing unit assigns at least one of a control function and a switch function to a relative movement of the surface structure in the sub-area.

### CROSS REFERENCE TO PRIOR APPLICATIONS

Priority is claimed to German Patent Application No. DE 10 2016 109 142.1, filed May 18, 2016. The entire disclosure of said application is incorporated by reference herein.

### FIELD

The present invention relates to an input device comprising an input area and an optical or capacitive sensor which is aligned with its scan to detect a surface structure of a finger touching the input area, in particular the dactylogram of a finger, in the scan area defined by the detection area of the sensor. Such sensors are regularly used to identify and authenticate users. Such sensors are also known to be used to analyze the scan area for movement of the input means, herein the finger, via a chronologically successive and multiple detection, in order to recognize the operation as an input following movement of the surface structure in the scan, and hence to assign a control function or a switch function, for example, to perform a cursor control.

### BACKGROUND

No input devices have to date been described which have a sensor that in particular capacitively detects the scan area which are operated both in a first mode, wherein identification via the surface structure detected by the sensor is performed, and in a second mode, wherein input is performed by detecting a movement made in the scan area, which is also called a detection area. The first mode is hereinafter referred to as the “identification mode” and the second mode is hereinafter referred to as the “input mode”. There have to date been concerns about a substantially desirable operation of an input device in the two modes in that risk of non-sufficient rapidity of signal processing and data processing in movement detection in the input mode was presumed, in particular if cursor control, in particular a control that is maximally continuous and immediately subsequent to the input, was envisaged.

### SUMMARY

An aspect of the present invention was to provide an input device that is capable of being operated in both of the above-described modes, and which is in particular capable of being operated without any delay or tardiness felt by the user while operating in the input mode.

In an embodiment, the present invention provides an input device which includes an input area, an optical or capacitive sensor comprising a scan area, and an analyzing unit. The optical or capacitive sensor is configured to detect a surface structure of a finger touching the input area in the scan area. The input device is configured to be operated in an identification mode where the surface structure located in the scan area is detected via the optical or capacitive sensor. The input device is also configured to be operated in an input mode where at least a sub-area of the scan area is detected at least once via the optical or capacitive sensor and is analyzed by the analyzing unit so that the analyzing unit assigns at least one of a control function and a switch function to a relative movement of the surface structure in the sub-area.

### BRIEF DESCRIPTION OF THE DRAWINGS

The present invention is described in greater detail below on the basis of embodiments and of the drawings in which:

FIG. 1 shows a schematic representation of a use of the present invention of an embodiment of the input device according to the present invention;

FIG. 2 shows a schematic representation of the components of the input device according to the invention of FIG. 1;

FIG. 3 shows a schematic representation of a first embodiment of the input process according to the present invention; and

FIG. 4 shows a schematic representation of a second embodiment of the input process according to the present invention.

### DETAILED DESCRIPTION

The input device according to the present invention comprises an input area and an optical or capacitive, for example, a capacitive sensor, which, with its scan area, is aligned to detect a surface structure of a finger touching the input area in the scan area of the sensor. The sensor can, for example, be designed to detect a surface structure of a finger in a locally resolved manner. Such capacitively operating sensors are, for example, described in WO 151 27 046 A1, the disclosure of which is incorporated by reference herein.

The input area can, for example, be about the size of an average fingertip of an adult. The input area can, for example, define a maximum area of less than 2.5 cm², for example, equal to or less than 1 cm².

The input device of the present invention is designed to be operated in an identification mode, wherein the surface structure in the scan area is detected in a single scan step, i.e., across the entire detection range of the sensor. The input device of the present invention is further designed to be operated in an input mode, wherein at least a sub-area of the scan area, i.e., the entire scan area or, for example, a sub-area of the scan area that in regard of the area's extent is smaller, is detected at least once, for example, several times, i.e., it is scanned by the sensor and is analyzed by an analyzing unit, in order to assign a control function or a switch function to a relative movement of the surface structure, for example, the finger, in the sub-area. An input device is thereby provided which allows the identification of a user and optionally an authentication of the user, while simultaneously allowing for an input, and thus permitting an operation via the same input device. An input in the sense of the present invention means the movement of a finger in the input area which is suitable to be detected in the input mode and to be assigned to a switch function and/or to a control function. Authentication in the sense of the present invention comprises, for example, following identification, the comparison of data acquired in the preceding identification to saved data that have been acquired in the still chronologically preceding identification steps, in order to assign a control function and/or a switch function solely upon sufficient conformity or, conversely, to deny the assignment thereof.

In an embodiment of the input device according to the present invention, in the identification mode, in at least one identification step, characteristic points of the surface structure can, for example, be detected and saved while utilizing the entire scan area, and in the input mode, a subset of all characteristic points that have been detected in one or more of the preceding identification steps and located in a sub-area are evaluated in order to assign a control function to a relative movement of the characteristic points. The term characteristic points is to be broadly interpreted and does not necessarily require punctiform expansion, and consequently, it may be zones having specific expansion and/or irregular contour characteristic to the surface structure of the finger of the user. It is not moreover necessarily required to be characteristic points individual to the respective user, especially if an authentication is omitted. As characteristic points, for example, minutiae or a selection of one or more specific minutiae are assumed that generally represent the endings and furcations of the friction ridge of the human finger print. Specific minutiae can, for example, include a ridge ending, a single furcation, a bifurcation, a trifurcation, a single vortex, a double vortex, a lateral contact, a hook, a point, an interval, an X line, a single bridge, a double bridge and/or a continuous line. In regard to the detection of characteristic points in a dactylogram of a finger, reference is made, for example, to US 2010/150411 A1, the contents of which are incorporated by reference herein.

In an embodiment of the present invention, provision can, for example, be made for the input device to be designed for repeatedly performing the identification mode in several chronological identification steps, wherein the characteristic points of the surface structure are gathered and saved, and in the input mode, at least one saved characteristic point of an identification step chronologically located even in advance of the preceding identification step is made use of. The input device according to the present invention may thereby be realized, for example, with a comparably small scan area, i.e., the scan area having the expansion of a dimension below the fingertip. Installation space is thus saved and, for example, integration of the input device into a stirring wheel is enabled.

In an embodiment of the present invention, the input device can, for example, be designed so that the sub-area, during operation performed in the input mode, is selected so that the sub-area comprises at least two, for example, exactly two, neighboring characteristic points, for example, having the smallest distance. It is thereby possible to more accurately detect a movement input, and it is in particular possible to recognize movement of the finger having a rotational portion of movement on the input area. The number of the characteristic points in the respective sub-area can, for example, be limited by selecting the size of the sub-area so that maximally five, for example, maximally three, for example, maximally two characteristic points are enclosed in the sub-area. Expense in data processing is thereby reduced.

In an embodiment of the present invention, provision can, for example, be made so that a sub-area of the scan area is repeatedly scanned, wherein the sub-area undergoes a prediction of movement due to a movement detected via a predicted acquisition of the sub-area, in order to perform tracking of the sub-area with the aid of the prediction of movement.

In an embodiment of the present invention, provision can, for example, be made that the sub-area operating in the input mode is selected at least during the first detection that follows the first identification mode so that the sub-area is arranged spaced apart of the edge of the scan area and within the scan area of the preceding identification step in order to provide reliable recognition of movement.

In an embodiment of the present in invention, provision can, for example, be made so that during operation in the input mode, one sub-area among several possible sub-areas that, for example, are applicable due to an equal number of characteristic points and the size of the sub-area being equal, is selected so that the distance to an external characteristic point that is outside the selected sub-area is lower in comparison to the remaining sub-areas, wherein the external characteristic point is located in the scan area of the preceding identification step and/or in the scan area of a chronologically still further preceding identification step. A simple resetting of the sub-area, especially in repeated detection during operation in the input mode, is thereby allowed.

The present invention further relates to an input process comprising the following steps:

Providing an input device comprising an input area and an optical or capacitive sensor which is aligned with its scan area to detect a surface structure of a finger touching the input area in the scan area. The process provides for operation of the input device in an identification mode, wherein the surface structure is detected in the scan area. The process furthermore provides a chronologically subsequent operation of the input device in an input mode, wherein at least a sub-area of the scan area is detected and is analyzed at least one time, for example, several times, in order to assign a control function to a relative movement of the surface structure in the sub-area. A process is thereby provided that enables identification, eventually also authentication of a user, in the above-described sense, while simultaneously allowing input and thus operation via the same input device. Reference is further made to the above explanation of terms.

In an embodiment of the process of the present invention, in the identification mode, characteristic points of the surface structure are detected and saved in at least one identification step, and in the input mode, a subset of all characteristic points detected in one or more preceding identification steps and located in the sub-area is analyzed, in order to assign a control function to a relative movement of the characteristic points. The term characteristic points is to be interpreted as indicated above.

In an embodiment of the present invention, provision can, for example, be made to repeatedly perform the identification mode in several chronological identification steps, wherein characteristic points of the surface structure are gathered and saved, and, in the input mode, at least one saved characteristic point of an identification step chronologically located even in advance of the preceding identification step is made use of. The input device according to the present invention may thereby, for example, be realized with a comparably small scan area, i.e., with a dimension of the scan area below the expansion of a fingertip.

In an embodiment of the process of the present invention, provision can, for example, be made that the sub-area, during operation in the input mode, is selected so that the sub-area comprises at least two, for example, exactly two, neighboring characteristic points.

Input of movement is thereby to be detected more accurately, and it is in particular possible to recognize movement of the finger on the input area having a rotational portion of movement. The number of the characteristic points in the respective sub-area can, for example, be limited by selecting the size of the sub-area so that maximally five, for example, maximally three, for example, maximally two characteristic points are enclosed in the sub-area. Expense in data processing is thereby reduced.

In an embodiment of the input process according to the present invention, provision can, for example, be made for a sub-area of the scan area to be scanned several times, wherein the sub-area, due to a movement detected by way of the preceding detection of the sub-area, undergoes a prediction of movement, in order to perform tracking of the sub-area with the aid of the prediction of movement.

In an embodiment of the present invention, provision can, for example, furthermore be made so that the sub-area during operation in the input mode, at least in the first detection following the identification mode, is selected so that the sub-area is arranged spaced apart of the edge of the scan area and is arranged within the scan area of the preceding identification step in order to allow reliable recognition of movement.

In an embodiment of the present invention, provision can, for example, be made that while operating in the input mode, one among several possible sub-areas that, for example, would be applicable due to an equal number of characteristic points, the size of the sub-area being constant, is selected so that the distance to an external characteristic point located outside the selected sub-area is smaller in comparison to the remaining sub-areas, wherein the external characteristic point is in the scan area of the preceding identification step and/or in the scan area of a chronologically still further preceding identification step. A simple resetting of the sub-area, in particular in repeated detection during operation in the input mode, is thereby allowed. The present invention further relates to the use of the input device in one of the above-described embodiments in a vehicle, in particular while being arranged in a steering wheel of the vehicle, in particular in a steering wheel spoke belonging to the steering wheel and supporting the steering wheel rim.

Reference is made to the subsequent drawings with respect to further embodiments of the process of the present invention and the input device of the present invention, respectively. The drawings are thereby merely to be understood as examples.

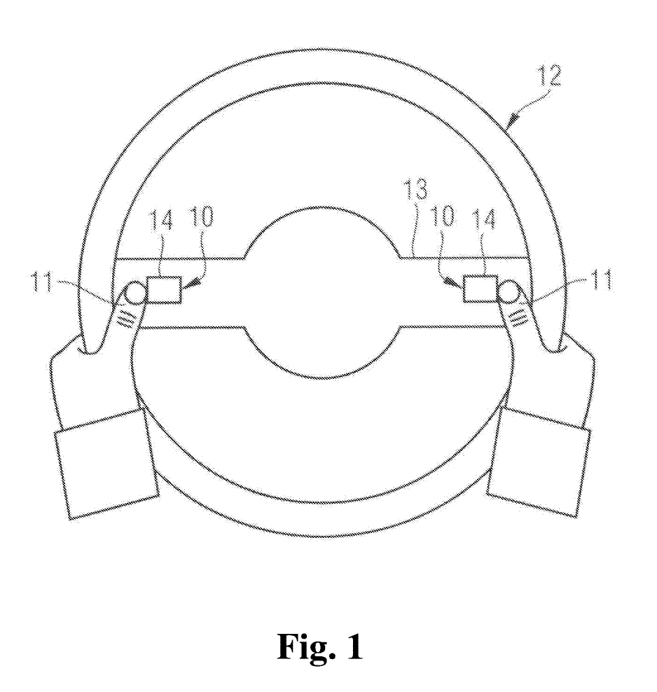

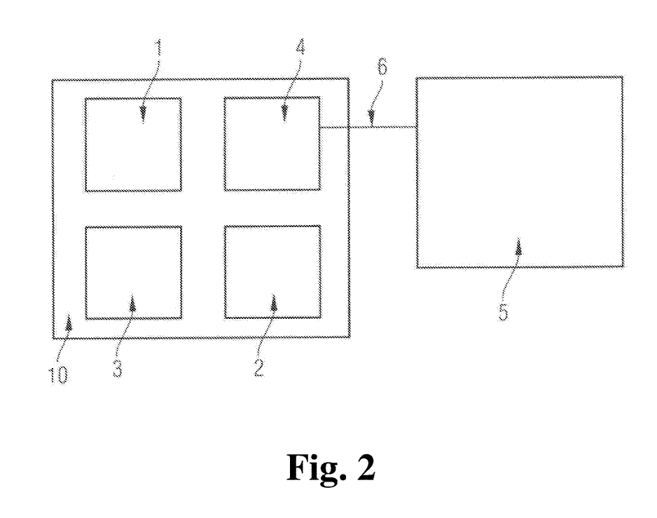

FIG. 1 represents a use according to the present invention of an embodiment of the input device 10 according to the present invention in a vehicle, specifically as a variant integrated into the steering wheel 12 of the vehicle, wherein any two of the input devices 10 are provided, and each of the input devices 10 is integrated in one of the steering wheel spokes 13, supportingly carrying the steering wheel rim at the impact absorber, so that the input area 14 of the input device 10 is essentially accommodated in the surface of the associated steering wheel spoke 13, respectively. The input area 14 is formed and arranged as a contact surface for a finger 11, here the thumb of a user, which is here the driver. Touch of the input area 14 is monitored by a capacitive sensor 1, the scan area of which is aligned and formed so that it is capable to detect the surface structure of the finger 11 falling in the scan area in the range of the input area 14 in one single detection process. FIG. 2 shows the basic design of the input device according to the present invention 10. The input device 10 comprises a capacitive sensor 1 which, as mentioned above, is aligned to detect a surface structure of a finger touching the input area 14 (a representation of which is omitted in FIG. 2). The sensor 1 is connected with an analyzing unit 2 in an electrically conductive manner. In cooperation with the sensor 1, the analyzing unit 2 provides for operation of the sensor 1 both in an identification mode and in an input mode. The detection performed one time or several times in the identification mode is for detection of a section of the surface structure of the finger within the entire scan area in order to perform an identification and eventually an authentication of the driver. Embodiments are conceivable wherein this detection is performed several times to allow larger-area detection of the surface structure, i.e., a detection exceeding the scan area. The input mode is provided to identify a movement of the surface structure relative to the touch surface in order to assign a control function and/or a switch function to the relative movement. Depending on the embodiment, both modes require the provision of a memory 3 connected with the analyzing unit 2 so that data concerning components, zones, characteristic points of the surface structure or eventually the sections of the surface structure exceeding the scan area can be saved. A communication unit 4 connected with the analyzing unit 2 communicating with a central vehicle calculating unit 5 via a connection 6 is furthermore provided in order to, among others, transmit the result of the assignment to a control function or switch function, performed by the analyzing unit 2, to the central vehicle calculating unit 5, so that, for example, a change of the switching status for a vehicle component may be initiated by the central vehicle calculating unit 5.

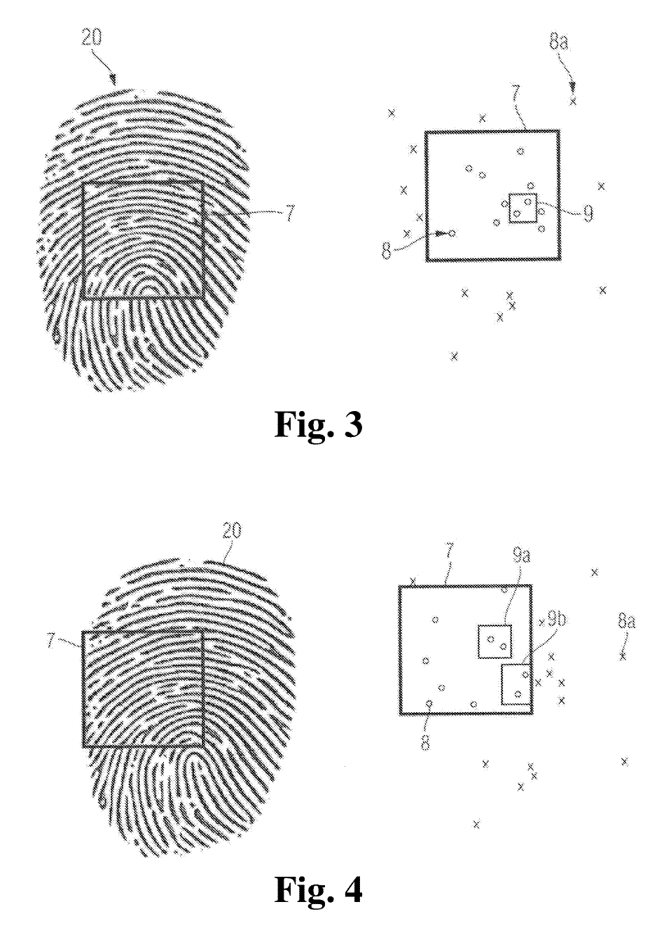

A first embodiment of the input process according to the present invention is explained in detail in FIG. 3. The dactylogram, i.e., the surface structure 20 of a finger is detected in the identification mode in the entire scan area 7. By way of the surface structure characteristic points 8, for example, the endings and furcations of the friction ridge of the human finger print within the scan area 7 will be detected. The subsequent input mode is for assignment of a control function or switching function to the movement of the surface structure 20, especially the movement of isolated characteristic points 8. For reliable movement analysis, change of position of a few, for example, two characteristic points 8 is used. A sub-area 9 of the scan area 7 is as small as possible, comprising the respective characteristic points 8, is used therefor and is detected at least one time in the input mode, for example, several times. The sub-area 9 generally maintains its position within the scan area 7. Embodiments of the input process according to the present invention are, however, conceivable, wherein a dynamic tracking due to a prediction of movement concerning the surface structure is performed. By way of the changes of position of the characteristic points located in the sub-area 9, a control function occurs corresponding to the change of movement, such as a cursor control on the display screen. The change of position is, for example, detected with the aid of the difference of the detection of the scan area 7 made in the identification mode and the detection of the sub-area made in the input mode. In an embodiment, there may, for example, also be performed several chronologically successive detections of the sub-area 9 in order to identify the associated input of movement with the aid of the detected changes of position of the respective characteristic points 8 within the sub-area 9. The surface of the sub-area 9 is smaller than that of the scan area 7 in order to simplify and promote analysis due to data reduction. The surface size of the sub-area 9 is selected by the person skilled in the art according to the expected velocity with which the input by fingertip is performed or is to be detected, and also dependent of the frequency, with which the chronological detection eventually occurs. In an embodiment, the sub-area 9 is furthermore positioned so that it not only comprises exactly two characteristic points 8, but also so that the sub-area 9 is arranged spaced apart from the edge of the scan area 7. It is thereby possible, in the input mode, to substitute characteristic points 8 exceeding the sub-area 9 due to movement of the finger by the ones known in advance due to the detection in the identification mode of the scan area 7 and which “have migrated” into the sub-area 9, thus using the “migration movement” for analyzing in the input mode. In an alternative embodiment of the process of the present invention represented in FIG. 4, in the input mode, even marginal positions of the sub-area 9b are not excluded, but are included instead of positions spaced apart from the edge of the scan area 7 of the sub-area 9a due to a small distance to external characteristic points previously known, in order to perform analysis of movement with the aid of the characteristic points 8 included therein and of “migrated” external characteristic points 8a. External characteristic points 8a are thereby understood as points that have not been detected in the detection of the scan area 7 of a chronologically preceding operation in the identification mode, but, due to another positioning of the finger of another section of the dactylogram 10, have been acquired and saved in the chronologically still further preceding detection across the entire scan area 7.

The present invention is not limited to embodiments described herein; reference should be had to the appended claims. The features individually listed in the claims can thereby be combined with each other in any technologically expedient way to show further embodiments of the present invention. The description, in particular in connection with the drawings, additionally characterizes and specifies the present invention.

What is claimed is:

1. An input device comprising:
an input area;
an optical or capacitive sensor comprising a scan area, the optical or capacitive sensor being configured to detect a surface structure of a finger touching the input area in the scan area; and
an analyzing unit,
wherein,
the input device is configured to be operated in an identification mode where the surface structure located in the scan area is detected via the optical or capacitive sensor, and
the input device is configured to be operated in an input mode where at least a sub-area of the scan area is detected at least once via the optical or capacitive sensor and is analyzed by the analyzing unit so that the analyzing unit assigns at least one of a control function and a switch function to a relative movement of the surface structure in the sub-area.

2. The input device as recited in claim 1, wherein,
in the identification mode, the input device is further configured to identify and to save, in at least one identification step, characteristic points in the surface structure detected by the optical or capacitive sensor, and
in the input mode, the input device is further configured to analyze a subset of all the characteristic points identified in one or several preceding identification steps which are located in the sub-area via the analyzing unit so as to assign the at least one of a control function and a switch function to the relative movement of the characteristic points.

3. The input device as recited in claim 2, further comprising:
a memory,
wherein,
the input device is further configured to repeatedly perform the identification mode in a plurality of identification steps which are performed chronologically during which the characteristic points of the surface structure are gathered and are saved in the memory as saved characteristic points, and
in the input mode, the input device is further configured so that the analyzing unit uses at least one of the saved characteristic points of an identification step which is performed chronologically even prior to a preceding identification step.

4. The input device as recited in claim 3, wherein the input device is further configured to select the sub-area during operation in the input mode by the analyzing unit so that the sub-area comprises at least two neighboring characteristic points.

5. The input device as recited in claim 4, wherein the sub-area during operation in the input mode is selected by the analyzing unit so that the sub-area is located spaced apart from an edge of the scan area and within the scan area of the preceding identification step.

6. The input device as recited in claim 5, wherein the input device is further configured so that, during operation in the input mode, one sub area is selected by the analyzing unit among several possible sub-areas so that a distance to an external characteristic point located outside of the selected sub-area is lower in comparison to the remaining sub-areas, the external characteristic point being located in at least one of the scan area of the preceding identification step and in the scan area of a chronologically even more preceding identification step.

7. The input device as recited in claim 6, wherein the input area is less than 2.5 cm².

8. An input process comprising:
providing an input device comprising,
an input area, and
an optical or capacitive sensor comprising a scan area, the optical or capacitive sensor being configured to detect a surface structure of a finger touching the input area in the scan area;
operating the input device in an identification mode so as to detect the surface structure located in the scan area; and
chronologically successively operating the input device in an input mode so as to detect and to analyze at least a sub-area of the scan area at least once so as to assign at least one of a control function and a switch function to a relative movement of the surface structure in the sub-area.

9. The input process as recited in claim 8, further comprising:
performing at least one identification step in which the input device is operated in the identification mode wherein characteristic points of the surface structure are identified and saved; and
in a subsequent operation in the input mode, analyzing a subset of all characteristic points identified in one or more preceding identification steps which are located in the sub-area in order to assign a control function or a switch function to a relative movement of the characteristic points.

10. The input process as recited in claim 9, further comprising:
repeatedly performing the identification mode in a plurality of chronologically successive identification steps so as to gather and save characteristic points of the surface structure, and
in the chronologically subsequent operation performed in the input mode, using at least one saved characteristic point of an identification step located chronologically even in advance of the preceding identification step.

11. The input process as recited in claim 9, wherein the sub-area is selected during an operation performed in the input mode so that the sub-area comprises at least two neighboring characteristic points.

12. The input process as recited in claim 9, wherein the sub-area is selected during operation performed in the input mode so that it is spaced apart from an edge of the scan area and is located within the scan area of a preceding identification step.

13. The input process as recited in claim 9, wherein,
during operation in the input mode, one of several possible sub-areas selected so that a distance to an external characteristic point located outside of a selected sub-area is smaller in comparison to the remaining sub-areas, and
the external characteristic point is located in the scan area of at least one of the preceding identification step and in the scan area of a chronologically even more preceding identification step.

14. A method of using the input device as recited in claim 8 in a vehicle, the method comprising:
providing an input device as recited in claim 8; and
using the input device in a vehicle.

15. The method as recited in claim 14, wherein the input device is used in a steering wheel of the vehicle.
